(19) United States
(12) Patent Application Publication
(10) Pub. No.: US 2014/0012792 A1
(43) Pub. Date: Jan. 9, 2014

(54) SYSTEMS AND METHODS FOR BUILDING A VIRTUAL SOCIAL NETWORK

(71) Applicant: QUANTA COMPUTER INC., Kuei Shan Hsiang (TW)

(72) Inventors: Ting-Han Huang, Kuei Shan Hsiang (TW); Yu-Chen Huang, Kuei Shan Hsiang (TW); Chia-Yi Wu, Kuei Shan Hsiang (TW); Shin-Hau Huang, Kuei Shan Hsiang (TW); Kang-Wen Lin, Kuei Shan Hsiang (TW)

(73) Assignee: QUANTA COMPUTER INC., Kuei Shan Hsiang (TW)

(21) Appl. No.: 13/736,280

(22) Filed: Jan. 8, 2013

(30) Foreign Application Priority Data
Jul. 6, 2012 (TW) 101124359

(51) Int. Cl. G06N 5/02

(52) U.S. Cl. CPC G06N 5/02
USPC 706/46

(57) ABSTRACT

A system for establishing a virtual social network including at least one emotion detector and a processing module is provided. The emotion detector detects emotional reactions of a plurality of users while they are watching a video to generate a plurality of detection signals. The processing module analyzes the detection signals to obtain emotion data corresponding to a plurality of time indices in the video, and analyzes content of the video to obtain metadata corresponding to the time indices in the video. Also, the processing module classifies the users into social groups according to the emotion data and the metadata.

### CROSS REFERENCE TO RELATED APPLICATIONS

This application claims priority of Taiwan Patent Application No. 101124359, filed on Jul. 6, 2012, the entirety of which is incorporated by reference herein.

### BACKGROUND OF THE INVENTION

1. Field of the Invention

The invention generally relates to the management of virtual social networks, and more particularly, to systems and methods for establishing a virtual social network by using emotional reactions of users as reference for user preferences and classifying the users into social groups, so that activity recommendations may be sent by the social groupings.

2. Description of the Related Art

With rapid developments in ubiquitous computing and networking, interpersonal interactions have changed a lot due to Computer Mediated Communication (CMC). Distinct from the traditional social networks, entirely new social relationships, i.e., the virtual social networks (or called “network communities”), have emerged from CMC, which includes asynchronous interactions via emails, Bulletin Board Systems (BBS), and Newsgroups, etc., and synchronous interactions via Internet Relay Chats (IRC), on-line games, and social networking sites, etc. All kinds of communications, such as for commercial transactions, interests sharing, and forging relationships, between users, may be easily and swiftly conducted through the open and handy nature of the virtual social networks.

However, the virtual social networks are established manually by managers of the virtual social networks or by user-defined rules, which consumes extra manpower. Take the BBS for an example, a plurality of different discussion forums are created by users having privileged rights, and each of the plurality of different discussion forums may be roughly considered as a respective social group. For instance, the users who join in the discussion forum A may be classified into a social group, and the users who join in the discussion forum B may be classified into another social group. Take a general social networking site as another example, a user may choose to add certain people into his/her contact list, and then define his/her own contact circles (i.e., micro social networks) which those in the contact list are respectively classified into, so that the user may post different messages or communicate different information to different contact circles.

Thus, it is desirable to have a method for automatically establishing a virtual social network and classifying users into social groups.

### BRIEF SUMMARY OF THE INVENTION

In one aspect of the invention, a system for establishing a virtual social network comprising at least one emotion detector and a processing module is provided. The emotion detector detects emotional reactions of a plurality of users while they are watching a video to generate a plurality of detection signals. The processing module analyzes the detection signals to obtain emotion data corresponding to a plurality of time indices in the video, and analyzes content of the video to obtain metadata corresponding to the time indices in the video. Also, the processing module classifies the users into social groups according to the emotion data and the metadata.

In another aspect of the invention, a method for establishing a virtual social network is provided. The method comprises the steps of: detecting, via at least one emotion detector, emotional reactions of a plurality of users while they are watching a video to generate a plurality of detection signals; analyzing the detection signals, via a processing module, to obtain emotion data corresponding to a plurality of time indices in the video; analyzing content of the video, via the processing module, to obtain metadata corresponding to the time indices in the video; and classifying the users into social groups, via the processing module, according to the emotion data and the metadata.

In yet another aspect of the invention, a system for establishing a virtual social network comprising a processing module is provided. The processing module analyzes a plurality of detection signals to obtain emotion data corresponding to a plurality of time indices in a video, analyzes content of the video to obtain metadata corresponding to the time indices in the video, and classifies the users into social groups according to the emotion data and the metadata.

Other aspects and features of the invention will become apparent to those with ordinary skill in the art upon review of the following descriptions of specific embodiments of the systems and methods for establishing a virtual social network.

### BRIEF DESCRIPTION OF DRAWINGS

The invention can be more fully understood by reading the subsequent detailed description and examples with references made to the accompanying drawings, wherein:

FIG. 1 is a block diagram illustrating a system for establishing a virtual social network according to an embodiment of the invention;

FIG. 2 is a block diagram illustrating a multimedia electronic device according to an embodiment of the invention;

FIG. 3 is a block diagram illustrating a virtual social network server according to an embodiment of the invention;

FIGS. 4A to 4C are schematic diagrams illustrating the method for establishing a virtual social network performed with the multimedia electronic devices according to an embodiment of the invention;

FIG. 5 is a schematic diagram illustrating the method for establishing a virtual social network performed with the multimedia electronic devices according to another embodiment of the invention;

FIG. 6 is a schematic diagram illustrating the method for establishing a virtual social network performed with the multimedia electronic devices according to yet another embodiment of the invention;

FIG. 7 is a concise flow chart illustrating the method for establishing a virtual social network according to an embodiment of the invention; and

FIG. 8 is a detailed flow chart illustrating the method for establishing a virtual social network according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

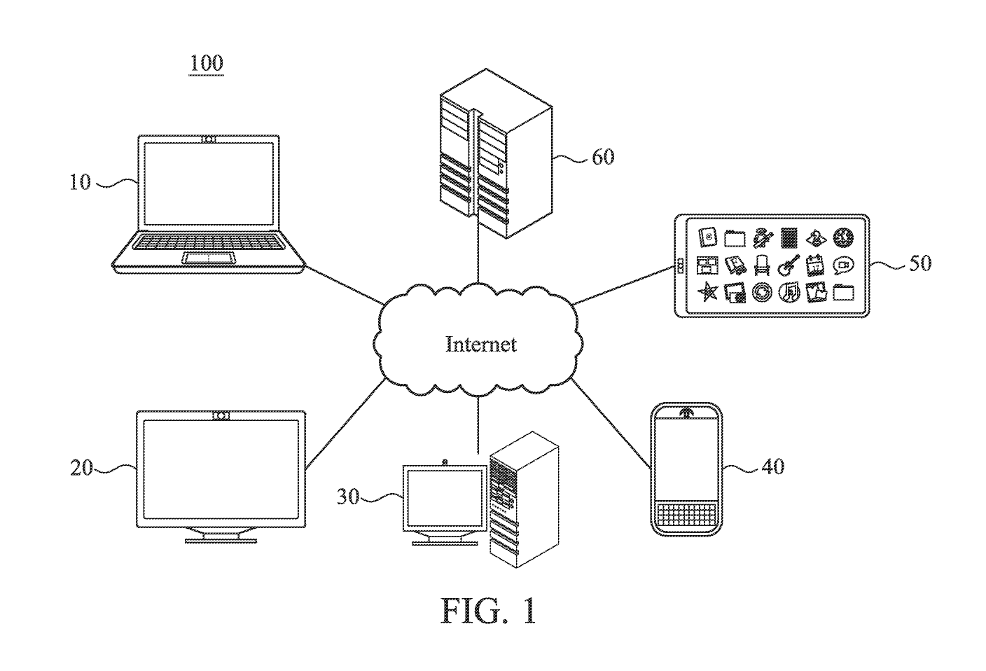

FIG. 1 is a block diagram illustrating a system for establishing a virtual social network according to an embodiment of the invention. The system 100 comprises the multimedia electronic devices 10 to 50, and the virtual social network server 60. The multimedia electronic device 10 (shown as a notebook computer), the multimedia electronic device 20 (shown as a All-In-One (AIO) computer), the multimedia electronic device 30 (shown as a desktop computer), the multimedia electronic device 40 (shown as a smart phone), and the multimedia electronic device 50 (shown as a tablet PC) may communicate with the virtual social network server 60 via the Internet. It is to be understood that the number of multimedia electronic devices is not limited to just 5 as illustrated above.

The multimedia electronic devices 10 to 50 may connect to the Internet via a wired or wireless connection, and may download and play a video, such as a film or a television show, requested by users from the Internet. Particularly, the multimedia electronic devices 10 to 50 may detect emotional reactions of users when they are watching the video (to be described in detail later). The virtual social network server 60 may be a computer or workstation setup on the Internet, for creating social networking relationships according to user information. Specifically, the virtual social network server 60 connects to the multimedia electronic devices 10 to 50 via the Internet, to receive the information concerning the film or television show watched by the users, and the detected emotional reactions of the users, thereby classifying the users into social groups according to the received information.

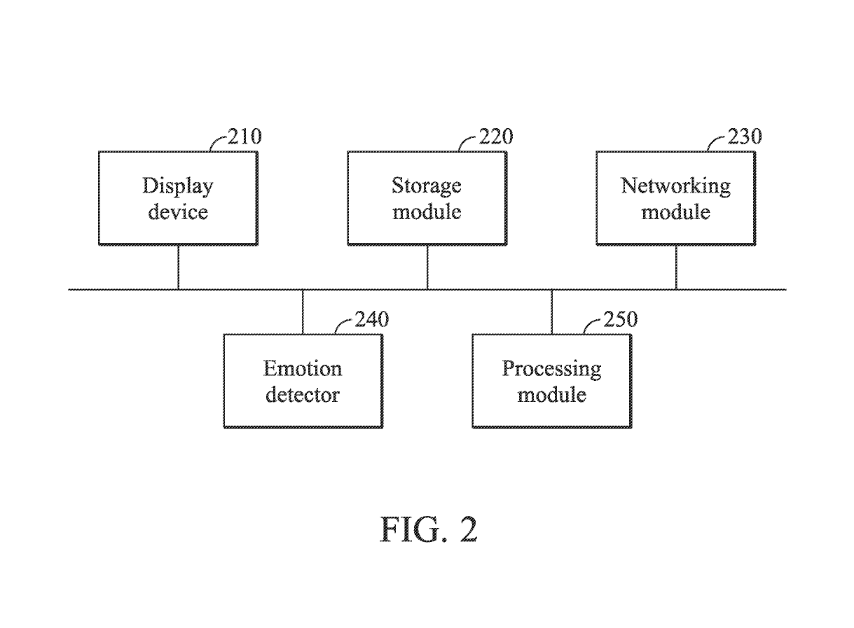

FIG. 2 is a block diagram illustrating a multimedia electronic device according to an embodiment of the invention. The multimedia electronic devices 10 to 50 may each comprise a display device 210, a storage module 220, a networking module 230, an emotion detector 240, and a processing module 250. The display device 210 may be a screen, panel, touch panel, or any device with display functionality. The storage module 220 may be a volatile memory, e.g., Random Access Memory (RAM), or non-volatile memory, e.g., FLASH memory, or hardware, compact disc, or any combinations thereof. The storage module 220 is used for storing program code which is executable by the processing module 250 for cooperating with the virtual social network server 60 to perform the method for establishing a virtual social network in the present invention. The networking module 230 is responsible for providing network connections using wired or wireless technology, such as Ethernet, Wireless Fidelity (WiFi), mobile telecommunications technology (e.g., GSM, WCDMA, WiMAX, and LTE, etc.), Asymmetric Digital Subscriber Line (ADSL), Cable Modem, or other technologies. The emotion detector 240 may contain a video camera, microphone, pressure sensor, and/or other detectors capable of detecting emotional reactions of users and generating detection signals according to the emotional reactions. Specifically, the detection signals may be the image signals generated by a video camera capturing the facial expressions of users, the voice signals generated by a microphone capturing the words or sounds made by users, and/or the surface pressure signals generated by a pressure sensor measuring the pressure caused by users on the surface of the multimedia electronic device. The detection signals generated by the emotion detector 240 and the corresponding timing information may be stored in the storage module 220, and later be sent to the virtual social network server 60 instantly or at the end of the film or television show. The processing module 250 may be a general purpose processor or a Micro Control Unit (MCU) which is responsible for executing machine-readable instructions to control the operations of the display device 210, the storage module 220, the networking module 230, and the emotion detector 240.

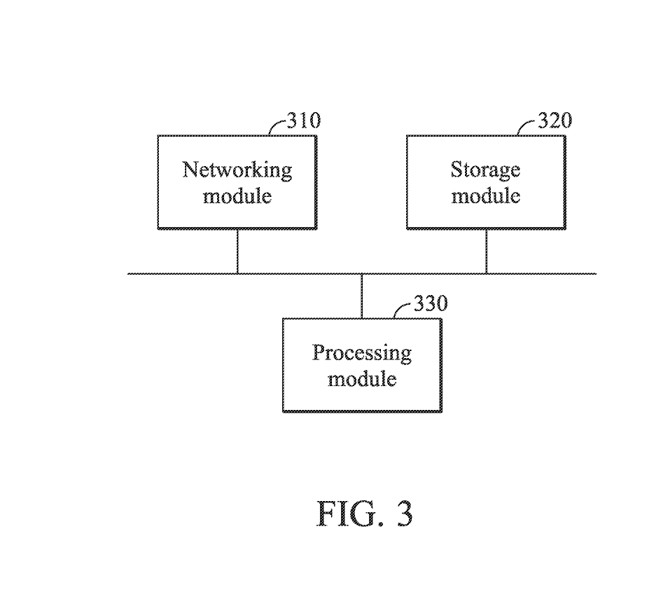

FIG. 3 is a block diagram illustrating a virtual social network server according to an embodiment of the invention. The virtual social network server 60 comprises a networking module 310, a storage module 320, and a processing module 330. The networking module 310 is responsible for providing wired or wireless connections. The storage module 320 may be a volatile memory, non-volatile memory, hardware, compact disc, or any combinations thereof, and is used for storing digital data, including the detection signals received from the multimedia electronic devices 10 to 50 via the networking module 310, and the information required for social network classifications. The processing module 330 may be a general purpose processor or an MCU which is responsible for executing machine-readable instructions to control the operations of the networking module 310 and the storage module 320. In addition, the storage module 320 is also used for storing program code which is executable by the processing module 330 for cooperating with the multimedia electronic devices 10 to 50 to perform the method for establishing a virtual social network in the present invention.

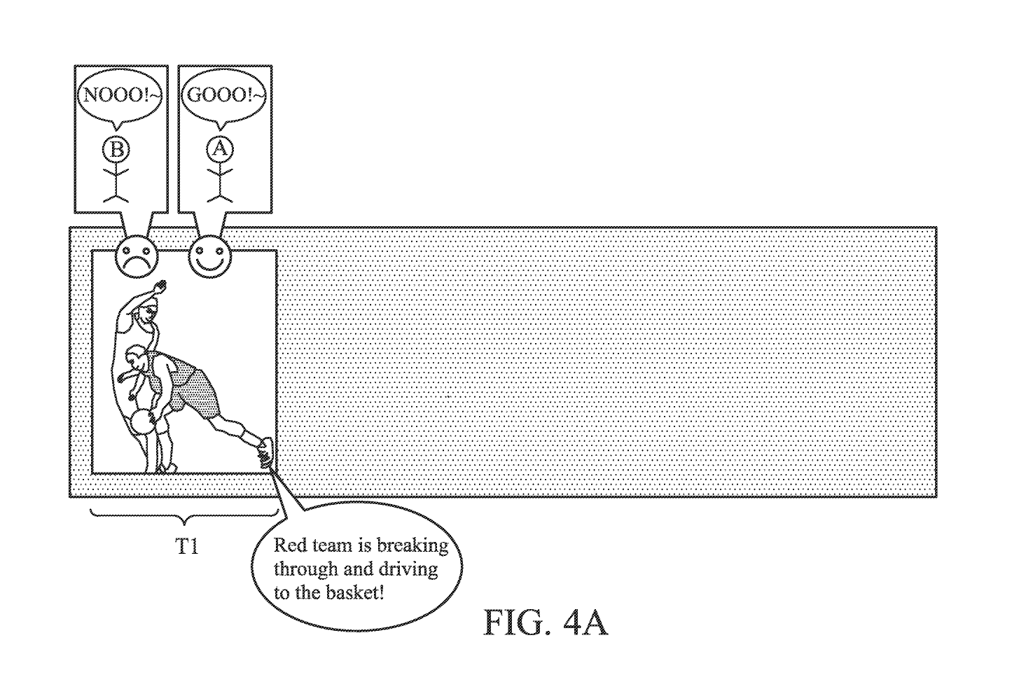

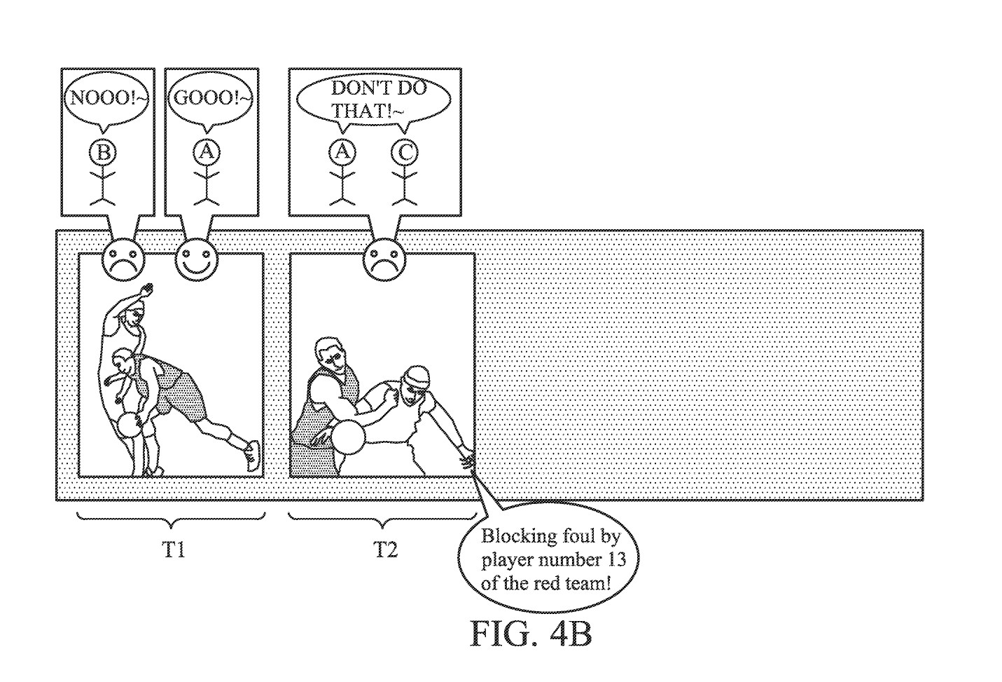

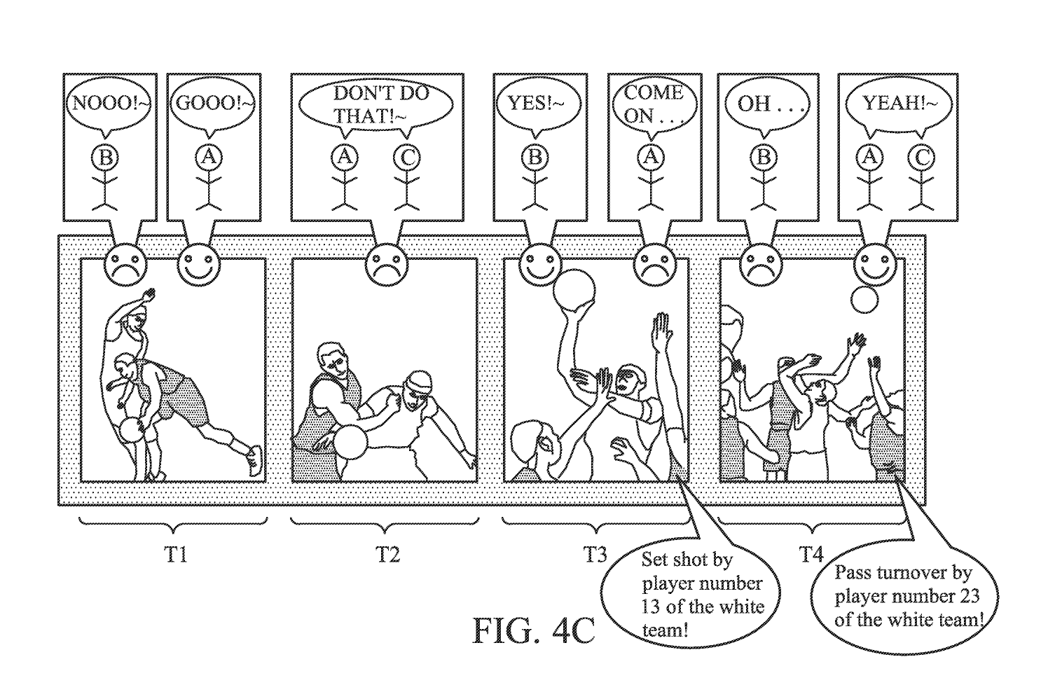

FIGS. 4A to 4C are schematic diagrams illustrating the method for establishing a virtual social network performed with the multimedia electronic devices according to an embodiment of the invention. In this embodiment, the multimedia electronic devices 10, 20, and 30 are operated by Users A, B, and C, respectively, for watching the same video, e.g., a live telecast of an NBA basketball game. In other embodiments, Users A, B, and C may watch the telecast of the NBA basketball game using the same multimedia electronic devices, but, the invention is not limited thereto. Note that, the video (i.e., the telecast of the NBA basketball game) may be obtained from a multimedia database (not shown) in the virtual social network server 60 or an on-line video site (e.g., YouTube®). If the video is obtained from a multimedia database (not shown) in the virtual social network server 60, the virtual social network server 60 may establish the relationships between the video and the multimedia electronic devices, to perform subsequent operations (will be described in detail later). Otherwise, if the video is obtained from an on-line video site, the multimedia electronic devices would send the information concerning the video and the on-line video site to the virtual social network server 60, so that the virtual social network server 60 may perform subsequent operations using the received information. In one embodiment, the multimedia electronic devices 10 to 50 may install program code when registering with the virtual social network server 60, to automatically perform the method for establishing a virtual social network upon logging in with the virtual social network server 60.

At first, FIG. 4A depicts that, at the first time index T1 of the video, a player of the red team (denoted with a meshed vest) drives forward to the basket, and the announcer of the basketball game says: “red team is breaking through and driving to the basket!”. Meanwhile, the multimedia electronic device 10 detects the facial expression (a smile) and the words of User A: “G0000000!˜”, and the multimedia electronic device 20 detects the facial expression (a frown) and the words of User B: “NOOOOOOO!˜”. Thus, the multimedia electronic devices 10 and 20 respectively send the generated detection signals to the virtual social network server 60.

Since Users A, B, and C have registered (or logged in) to the virtual social network server 60 via the multimedia electronic devices 10, 20 and 30 before the basketball game starts, the virtual social network server 60 may obtain the information of the basketball game which is being watched by Users A, B, and C. At the first time index T1, the virtual social network server 60 may analyze the content of the video to obtain the metadata corresponding to the first time index T1. Specifically, the virtual social network server 60 may analyze the speech of the announcer (speech recognition) or the subtitle (text) displayed with the video (text recognition), and determine that the red team is currently winning. That is, the metadata may indicate that the red team is winning at the first time index T1. Subsequently, when receiving the detection signals from the multimedia electronic devices 10 and 20, the virtual social network server 60 may analyze the detection signals to obtain the emotion data corresponding to the first time index T1. According to the metadata and the emotion data, the virtual social network server 60 may determine that User A favors the red team and User B favors the white team (players are denoted with white vest). To further clarify, in this embodiment, a face detection or smile recognition technique may be employed to analyze the image signals of User A, and determine that User A is smiling. Also, a speech recognition technique may be employed or an intonation analysis may be performed on the voice signals of User A to analyze the verbal content, average pitch, instantaneous pitch, and pitch period, and determine that the words said by User A (“GOOOOOOO!˜”) are accompanied with a pleased emotional expression. That is, the emotion data of User A indicates that User A is happy, and thus, it may be determined that User A favors the red team. To the contrary, User B may be determined to appear having a frown by analyzing the image signals of User B, and the words said by User B (“NOOOOOOO!˜”) may be determined to be accompanied with an unpleasant emotional expression by analyzing the voice signals of User B. That is, the emotion data of User B indicates that User B is sad or depressed, and thus, it may be determined that User B favors the white team. In one embodiment, the obtainment of the emotion data corresponding to the first time index T1 may be performed by the virtual social network server 60 (such as the processing module 330), or may be performed by the multimedia electronic devices 10 and 20 and then the emotion data may be sent to the virtual social network server 60.

FIG. 4B depicts that, at the second time index T2 of the video, a blocking foul is made by a player of the red team, and the announcer of the basketball game says: “blocking foul by player number 13 of the red team!”. Meanwhile, the multimedia electronic devices 10 and 30 respectively detect the facial expressions (a smile) and the words of Users A and C: “DON'T DO THAT!˜”, and the multimedia electronic devices 10 and 30 send the detection signals to the virtual social network server 60. The virtual social network server 60, at the second time index T2, analyzes the content of the video to obtain the metadata corresponding to the second time index T2. Similar to the analysis of the content of the video described previously with respect to FIG. 4A, the metadata may indicate that the red team is losing at the second time index T2. Next, when receiving the detection signals from the multimedia electronic devices 10 and 30, the virtual social network server 60 analyzes the detection signals to obtain the emotion data corresponding to the second time index T2. According to the metadata and the emotion data, the virtual social network server 60 may determine that Users A and C favor the red team. Specifically, Users A and C may be determined to appear having frowns by analyzing the image signals of Users A and C, and the words said by Users A and C (“DON'T DO THAT!˜”) may be determined to be accompanied with unpleasant emotional expressions by analyzing the voice signals of Users A and C. That is, the emotion data of Users A and C indicate that Users A and C are sad or depressed, and thus, it may be determined that Users A and C favor the red team.

As the basketball game progresses, the virtual social network server 60 continues with collecting subsequent metadata and emotion data. FIG. 4C depicts that, at the third time index T3 of the video, the announcer of the basketball game says: “set shot by player number 13 of the white team!”, and Users A and B say: “COME ON . . . ” and “YES!˜”, respectively. Also, at the fourth time index T4 of the video, the announcer of the basketball game says: “pass turnover by player number 23 of the white team!”, and Users A and C say: “YEAH!˜” and User B says: “OH . . . ”. Similar to the previous determination steps with respect to FIGS. 4A and 4B, the virtual social network server 60 determines Users A, B, and C's favors towards the two teams according to the speech of the announcer, the subtitles of the video, and the detection signals, to eventually determine to classify Users A and C into a social group intrigued with the red team and classify User B into a social group intrigued with the white team.

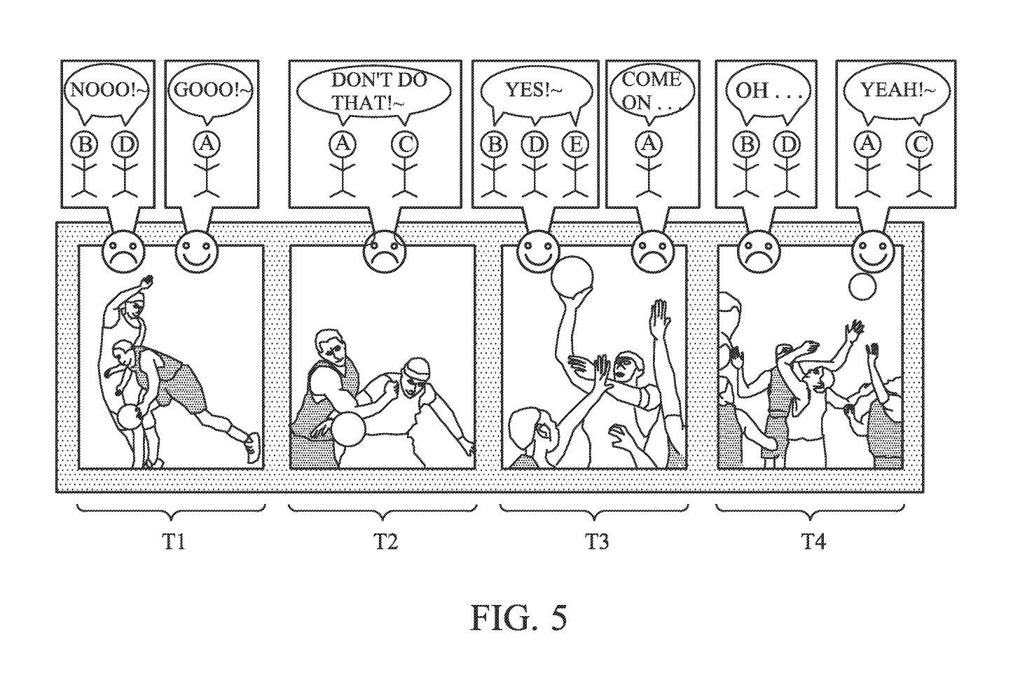

FIG. 5 is a schematic diagram illustrating the method for establishing a virtual social network performed with the multimedia electronic devices according to another embodiment of the invention. In this embodiment, the multimedia electronic devices 40 and 50 are operated by Users D and E, respectively, for watching the rebroadcast of the same NBA basketball game as described with respect to FIGS. 4A to 4C. As shown in FIG. 5, the multimedia electronic device 40 detects the facial expressions of User D at the first time index T1, the third time index T3, and the fourth time index T4. Also, the multimedia electronic device 50 detects the facial expressions of User E at the third time index T3. Next, the multimedia electronic devices 40 and 50 send the detection signals to the virtual social network server 60. Since Users D and E have registered (or logged in) with the virtual social network server 60 via the multimedia electronic devices 40 and 50 before the rebroadcast started, the virtual social network server 60 may obtain the information of the basketball game and determine that Users D and E are watching the same basketball game which was previously watched by Users A, B, and C. Thus, the virtual social network server 60 may take Users A, B, C, D, and E, all together, into account when classifying the social groups. Specifically, the virtual social network server 60 analyzes the content of the basketball game to obtain the metadata corresponding to the first time index T1, the third time index T3, and the fourth time index T4, thereby determining that the white team is losing at the first time index T1 and the fourth time index T4 and is the winning team at the third time index T3. After that, when receiving the detection signals from the multimedia electronic devices 40 and 50, the virtual social network server 60 analyzes the detection signals to obtain the emotion data corresponding to the first time index T1, the third time index T3, and the fourth time index T4. Eventually, the virtual social network server 60 determines that Users D and E favor the white team.

According to the analysis results from the embodiments of FIGS. 4A to 4C and FIG. 5, the virtual social network server 60 may classify Users A, B, C, D, and E into social groups. For example, Users A and C are classified into a social group intrigued with the red team, and Users B, D, and E are classified into a social group intrigued with the white team.

After classifying Users A, B, C, D, and E into social groups, the virtual social network server 60 may further use the activity event information of one user to send notifications, e.g., activity recommendations, to the other users in the same social group as the user. The notifications may be implemented by installing a program code, such as a plug-in or a custom browser, into the multimedia electronic devices 10 to 50 upon registration for collecting the activity event information of the users and reporting to the virtual social network server 60, such that the virtual social network server 60 may process the activity event information to identify the activities and to select the social groups related to the activities for sending of notifications. In one embodiment, the notifications may be activity recommendations. For example, when User A is watching another basketball game of the red team on the multimedia electronic device 10 after registering and logging in with the virtual social network server 60, the multimedia electronic device 10 may send the activity event information to the virtual social network server 60. The virtual social network server 60 may process the activity event information to determine that the activity event is related to a basketball game of the red team, and then select a social group intrigued with the red team to send the activity recommendation. Thus, User C may receive the activity information and then watch the basketball game on the multimedia electronic device 30 or forward the information of the basketball game to his/her friends according to the activity recommendation. In one embodiment, when User A inputs a reminder for watching a forthcoming basketball game of the red team in a calendar application on the multimedia electronic device 10, the virtual social network server 60 may send an activity recommendation to the multimedia electronic device 30 for User C, so that User C may be aware of the forthcoming basketball game of the red team or the date and time of the basketball game may be automatically put into a calendar application on the multimedia electronic device 30 for User C according to the activity recommendation. In another embodiment, when User A purchases a ticket online to a basketball game of the red team via the multimedia electronic device 10, the virtual social network server 60 may send a notification about the ticket purchase to the multimedia electronic device 30 for User C. In yet another embodiment, when User A reads an online article or news about the red team on the Internet via the multimedia electronic device 10, the virtual social network server 60 may employ the Natural Language Processing (NLP) technique, and the Data Mining and Text Mining (DM/TM) technique, etc., to analyze the content of the article or news to determine that the article or news is about the red team, and then send a notification about the article or news to the multimedia electronic device 30 for User C.

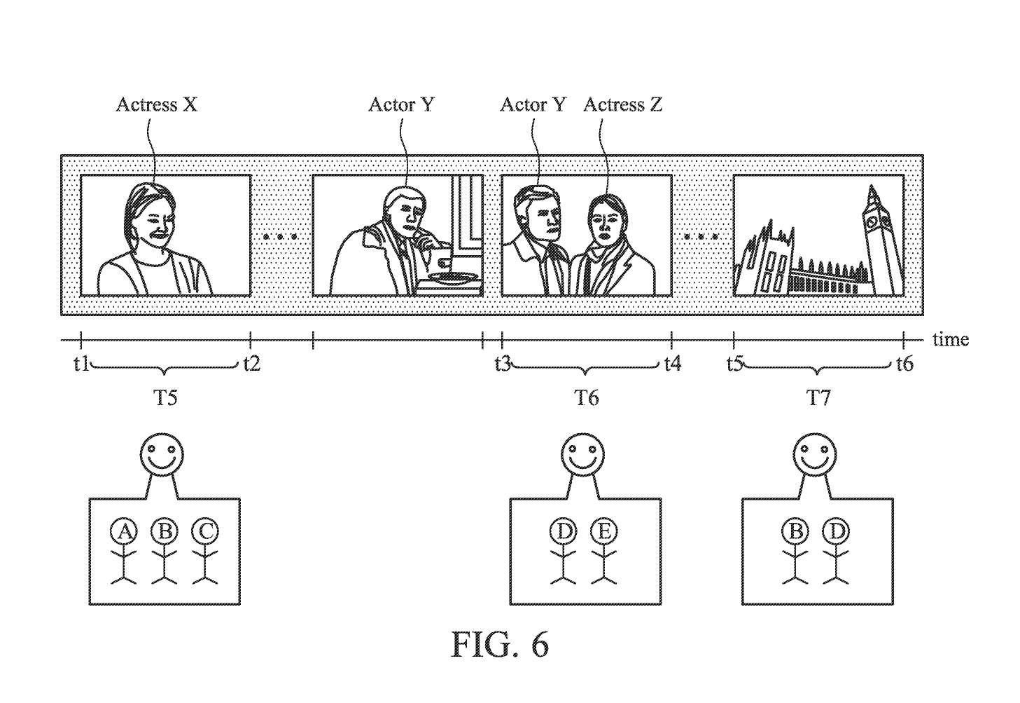

Although, in FIGS. 4A to 4C and FIG. 5, the users are classified into only two social groups according to the characteristics of a basketball game, the method for establishing a virtual social network of the invention may also be applied to other video content, such as a live/rebroadcasted golf game, or a live/rebroadcasted billiards game, etc., which involves more than 2 classification groupings. For example, several social groups may be formed to each represent the preference for a particular player in a game. Alternatively, the method for establishing a virtual social network of the invention may also be applied to a film in which visual objects which appear in the film (including landmarks, and actors/actresses, etc.) or the changes in the scenes may be the bases for the classification of social groups, as will be described later in reference to FIG. 6.

FIG. 6 is a schematic diagram illustrating the method for establishing a virtual social network performed with the multimedia electronic devices according to yet another embodiment of the invention. In this embodiment, the multimedia electronic devices 10 to 50 are operated by Users A, B, C, D, and E, respectively, for watching the same film at the same time. At first, in the time interval t1˜42 (corresponding to the time index T5), a close-up of Actress X is shown in the film. Meanwhile, the multimedia electronic devices 10, 20, and 30 detect the facial expressions (with smiles) of Users A, B, and C, respectively. Later, Actor Y appears in the frame of the film before the time t3, and Actress Z appears in the frame with Actor Y at the time t3, and then Actress Z leaves the frame of the film at the time t4 (the time interval t3˜44 is corresponding to the time index T6). That is, changes in the scenes occur at the time t3 and t4. Meanwhile, the multimedia electronic devices 40 and 50 detect changes of the facial expressions (from straight faced to smiling) of Users D and E in the time t3, and then detect changes of the facial expressions (from smiling to straight faced) of Users D and E in the time t4 again. Subsequently, in the time interval t5˜t6 (corresponding to the time index T7), the noted landmark, the Big Ben clock, appears in the frame of the film, and the multimedia electronic devices 20 and 40 detect the facial expressions (with smiles) of Users B and D. In addition to analyzing the content of the film to obtain metadata corresponding to the time indices T5˜T7, the virtual social network server 60 also receives the detection signals from the multimedia electronic devices 10 to 50 to obtain the emotion data corresponding to the time indices T5˜T7. In this embodiment, the virtual social network server 60 may analyze the images of the film to determine that the visual objects are Actress X, Actor Y, and Actress Z, and the Big Ben clock. According to the metadata and the emotion data, the virtual social network server 60 may classify Users A, B, and C into a social group intrigued with Actress X, classify Users D and E into a social group intrigued with Actress Z, and classify Users B and D into a social group intrigued with the Big Ben clock.

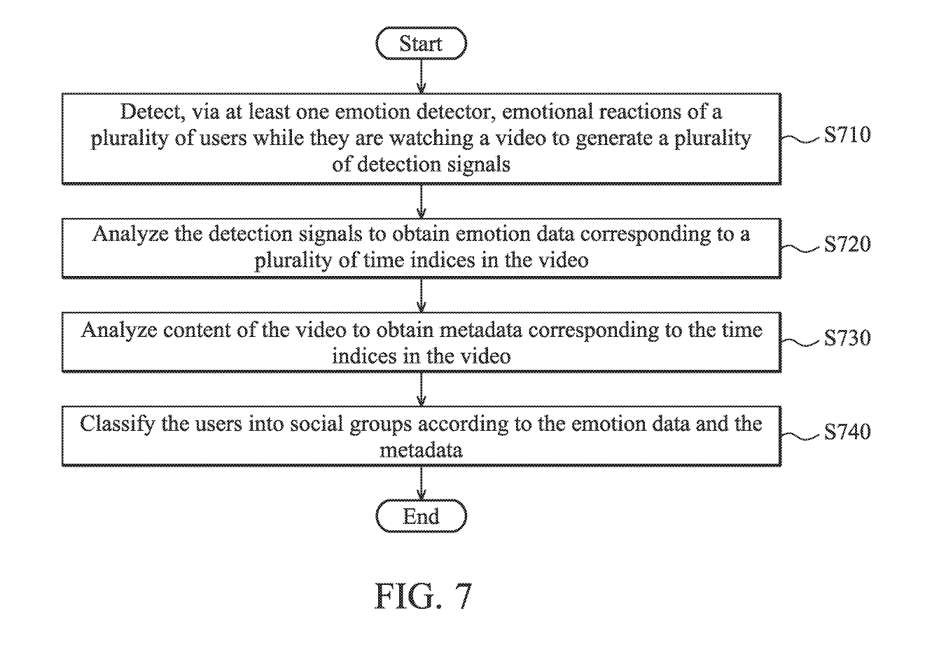

FIG. 7 is a concise flow chart illustrating the method for establishing a virtual social network according to an embodiment of the invention. To begin, the emotional reactions of a plurality of users while they are watching a video (e.g., a film or television show) are detected via at least one emotion detector to generate a plurality of detection signals (step S710). The detection signals may be image signals or voice signals of the users, or may be surface pressure signals of the emotion detector. Next, the detection signals are analyzed to obtain emotion data corresponding to a plurality of time indices in the video (step S720), and the content of the video is analyzed to obtain metadata corresponding to the time indices in the video (step S730). The content of the video may comprise the visual objects, speech, text (e.g., subtitle), and/or scene-changing events in the video. Subsequently, the users are classified into social groups according to the emotion data and the metadata (step S740). In this embodiment, the method for establishing a virtual social network may be applied to the coordinated operations of the multimedia electronic devices 10 to 50 and the virtual social network server 60 in FIG. 1. For example, the step S710 may be performed by any one of the multimedia electronic devices 10 to 50, and the steps S720 to S740 may be performed by the virtual social network server 60.

By the classification of the social groups, the users having similar emotional reactions when watching the video may be classified into the same social group. After that, based on the activity event information of a user in the social group, notifications (e.g., activity recommendations) may be sent to the other users in the same social group. The activity event information may comprise the calendar information, web browsing information, on-line shopping information, and any other operation information associated with the multimedia electronic device operated by the user.

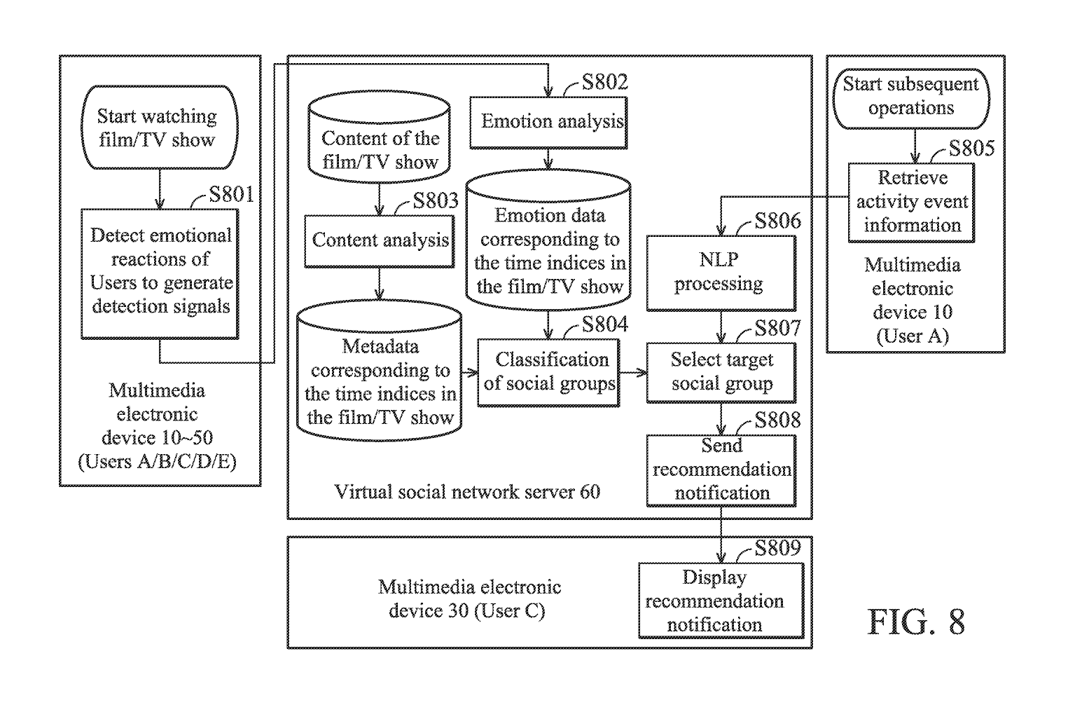

FIG. 8 is a detailed flow chart illustrating the method for establishing a virtual social network according to an embodiment of the invention. The multimedia electronic devices 10 to 50 are operated by Users A, B, C, D, and E, respectively, for watching the same film or television show at the same time or one after another. To begin, Users A to E have logged into the virtual social network server 60 via the multimedia electronic devices 10 to 50 before watching the film or television show, such that the virtual social network server 60 may obtain the information of the film or television show. When Users A to E start watching the film or television show, the multimedia electronic devices 10 to 50 detects the emotional reactions of Users A to E to generate the detection signals (step S801), and send the detection signals to the virtual social network server 60 to analyze and obtain the emotion data corresponding to the time indices in the film or television show (step S802). When Users A to E are watching the video or television show, the virtual social network server 60 analyzes the content of the video or television show to obtain the metadata corresponding to the time indices in the video or television show (step S803). Next, the virtual social network server 60 classifies Users A to E into social groups according to the emotion data and the metadata (step S804). Taking the embodiment of FIGS. 4A to 4C as an example, the social group consisting of Users A and C is associated with a tag—“red team”, and the social group consisting of Users B, D, and E is associated with a tag—“white team”.

Subsequently, when User A operates the multimedia electronic device 10 for arranging his/her personal schedule, the multimedia electronic device 10 retrieves the activity event information from the personal schedule of User A (step S805), and then sends the activity event information to the virtual social network server 60. The activity event information may comprise the web browsing information, on-line shopping information, and/or calendar information. The virtual social network server 60 employs the NLP technique and the DM/TM technique for processing the activity event information (step S806) to determine what the activity is. Then, the virtual social network server 60 selects the social group(s) related to the activity (step S807), and sends recommendation notifications to the other users in the selected social group(s) (step S808). Except for User A, the other users in the selected social group(s) receive the recommendation notifications on the multimedia electronic devices (step S809), and accordingly, determine how to proceed with the recommendation notifications, e.g., joining the activity with User A, or sharing the activity information with friends, etc. Taking the embodiment of FIGS. 4A to 4C as an example, when User A inputs a personal activity about the red time in the step S805, the virtual social network server 60 selects the social group tagged with “red team”. Since the selected social group comprises Users A and C, the recommendation notification is sent to User C in the step S808.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. A system for establishing a virtual social network, comprising:
at least one emotion detector, detecting emotional reactions of a plurality of users while they are watching a video to generate a plurality of detection signals; and
a processing module, analyzing the detection signals to obtain emotion data corresponding to a plurality of time indices in the video, analyzing content of the video to obtain metadata corresponding to the time indices in the video, and classifying the users into social groups according to the emotion data and the metadata.

2. The system of claim 1, wherein the detection signals comprise any combination of the following:
a plurality of image signals of the users;
a plurality of voice signals of the users; and
a surface pressure signal of the emotion detector.

3. The interactive multimedia system of claim 1, wherein the content of the video comprises any combination of the following:
a plurality of visual objects in the video;
speech in the video;
text in the video; and
a plurality of scene-changing events in the video.

4. The system of claim 1, wherein the processing module further, based on activity information of one of the users, sends notifications to the other users in the same social group as the user.

5. The system of claim 4, wherein the activity information of the user comprises any combination of the following:
calendar information of the user;
web browsing information of the user; and
on-line shopping information of the user.

6. A method for establishing a virtual social network, comprising:
detecting, via at least one emotion detector, emotional reactions of a plurality of users while they are watching a video to generate a plurality of detection signals;
analyzing the detection signals, via a processing module, to obtain emotion data corresponding to a plurality of time indices in the video;
analyzing content of the video, via the processing module, to obtain metadata corresponding to the time indices in the video; and
classifying the users into social groups, via the processing module, according to the emotion data and the metadata.

7. The method of claim 6, wherein the detection signals comprise any combination of the following:
a plurality of image signals of the users;
a plurality of voice signals of the users; and
a surface pressure signal of the emotion detector.

8. The method of claim 6, wherein the content of the video comprises any combination of the following:
a plurality of visual objects in the video;
speech in the video;
text in the video; and
a plurality of scene-changing events in the video.

9. The method of claim 6, further comprising, based on activity information of one of the users, sending notifications to the other users in the same social group as the user.

10. A system for establishing a virtual social network comprising a processing module, wherein the processing module analyzes a plurality of detection signals to obtain emotion data corresponding to a plurality of time indices in a video, analyzes content of the video to obtain metadata corresponding to the time indices in the video, and classifies the users into social groups according to the emotion data and the metadata.

11. The system of claim 10, wherein the detection signals are generated by an emotion detector detecting emotional reactions of a plurality of users while they are watching a video.
